(19) United States
(12) Patent Application Publication
(10) Pub. No.: US 2013/0074698 A1
(43) Pub. Date: Mar. 28, 2013

(54) MICROWAVE FILTER AIR PURIFICATION SYSTEMS, METHODS OF USE, AND METHODS OF DISINFECTION AND DECONTAMINATION

(71) Applicants: Chang-Yu Wu, Gainesville, FL (US); Wolfgang Sigmund, Gainesville, FL (US); Chang Yul Cha, Roseville, CA (US); Johannes C.M. Marijnissen, Breda (NL)

(72) Inventors: Chang-Yu Wu, Gainesville, FL (US); Wolfgang Sigmund, Gainesville, FL (US); Chang Yul Cha, Roseville, CA (US); Johannes C.M. Marijnissen, Breda (NL)

(21) Appl. No.: 13/703,078

(22) PCT Filed: Jun. 13, 2011
(86) PCT No.: PCT/US11/40134

§ 371 Date: Dec. 10, 2012

Related U.S. Application Data
(60) Provisional application No. 61/354,396, filed on Jun. 14, 2010.

(51) Int. Cl. B01D 46/42

(52) U.S. Cl. CPC B01D 46/4263
USPC 95/283; 96/225

(57) ABSTRACT

Embodiments of the present disclosure relate to microwave filter air purification systems, methods of using the microwave filter air purification systems, microwave absorbing filter packs, methods of degrading a contaminant, and the like.

### CROSS-REFERENCE TO RELATED APPLICATION

This application claims priority to U.S. provisional application entitled, “MICROWAVE FILTER AIR PURIFICATION SYSTEMS, METHODS OF USE, AND METHODS OF DISINFECTION AND DECONTAMINATION,” having Ser. No. 61/354,396, filed on Jun. 14, 2010, which is entirely incorporated herein by reference.

### FEDERAL SPONSORSHIP

This invention was made with Government support under Contract/Grant No. BB07PRO013, awarded by the Defense Threat Reduction Agency. The Government has certain rights in this invention.

### BACKGROUND

The disinfection of airborne pathogens has been given more attention due to the current H1N1 swine flu pandemic and the increasing threat of bioterrorism. Pathogenic bioaerosols are a danger to humans, crops and animals, and they can be generated from a variety of different sources; bioterrorism, occupational and agricultural processes. Even coughing and sneezing aerosolize pathogens which can remain suspended and infectious for days. Airborne pathogen transmission has a significant impact on human health causing over two million deaths worldwide every year. While there are a number of current bioaerosol control technologies including Ultraviolet Germicidal Irradiation (UVGI), antimicrobial filters, and photocatalytic oxidation, they have some noticeable weaknesses. The current technologies not only suffer from being expensive to install and maintain, but also are ineffective against highly resistant bacterial endospores (e.g., anthrax spores). Other airborne biological agents of concerns include allergens. Cost related to asthma in the US is estimated to be $20 billion.

In addition to biological agents, air also contains chemical compounds that may pose adverse health effects, such as volatile organic compounds (e.g., benzene, toluene), polycyclic aromatic hydrocarbons (e.g., naphthalene) and carbonyls (e.g., formaldehyde). Besides gaseous compounds, the chemicals of concern may also be in particulate form. There may also be intentionally released chemical warfare agents to harm people. Under these scenarios, it is important to ensure the removal and destruction of these chemical agents so that clean and safe breathing air is warranted. The presence of certain chemical compounds may also adversely affect manufacturing of select industrial products or precision analysis of samples that are sensitive to these contaminants. For example, in analyzing environmental samples, EPA traceable air instead of industrial grade air is used to ensure no artifact of given compounds. Effective removal of these chemicals from the air to be supplied to the industry or laboratory therefore is of critical importance.

Filtration is the most commonly used method for the removal of particles, viable and nonviable alike. For example, Heating, Ventilating and Air Conditioning (HVAC) filters are widely used in buildings to provide filtered breathing air to occupants. Filters are also used to provide fresh air to farm animals. Nevertheless, sustained viability of microorganisms collected on the filters, their growth and reaerosolization are a major concern. In addition to HVAC filters, personal respiratory filters loaded with pathogens also present a health and safety concern. In case of pandemic, the lack of personal respiratory filters may require contaminated filters to be reused, and therefore decontamination without damaging the filter is necessary. Similarly, chemical contaminants collected on filters may still be of concerns if they are volatile or reaerosolizable. Furthermore, filters loaded with these chemical and biological agents may be hazardous to persons who handle the replacement and disposal. In summary, it is critically important to effectively inactivate pathogens and decompose chemical contaminants collected on a variety of filter media.

### SUMMARY

In accordance with the purpose(s) of the present disclosure, as embodied and broadly described herein, embodiments of the present disclosure, in one aspect, relate to microwave filter air purification systems, methods of using the microwave filter air purification systems, microwave absorbing filter packs, methods of degrading a contaminant, and the like.

An embodiment of a microwave filter air purification system, among others, includes: a microwave source; and a microwave absorbing filter, wherein the microwave absorbing filter is positioned for an air flow to pass through the microwave absorbing filter, wherein the microwave source is positioned relative to the microwave absorbing filter so that the microwave radiation from the microwave source is absorbed by the microwave absorbing filter.

An embodiment of a microwave filter air purification system, among others, includes: a microwave source; and a microwave absorbing filter pack including a pair of microwave absorbing structures and a filter disposed between the pair of microwave absorbing structures, wherein the microwave absorbing filter pack is positioned for an air flow to pass through the microwave absorbing filter pack, wherein the microwave source is positioned relative to the microwave absorbing filter pack so that the microwave radiation from the microwave source is absorbed by the microwave absorbing filter pack.

An embodiment of a method of degrading contaminates, among others, includes: providing a microwave filter air purification system as described herein, trapping contaminants in the filter; exposing the microwave absorbing structures to microwave energy; and degrading the contaminants trapped in the filter.

An embodiment of a microwave absorbing filter pack, among others, includes: a pair of microwave absorbing structures and a filter disposed between the pair of microwave absorbing structures, wherein the pair of microwave absorbing structures and the filter are positioned for an air flow to pass through the pair of microwave absorbing structures and the filter, wherein the microwave source is positioned relative to the microwave absorbing filter pack so that the microwave radiation from the microwave source is absorbed by the microwave absorbing filter pack.

An embodiment of a method of degrading contaminants, among others, includes: providing a filter pack as described herein, trapping contaminants in the filter; exposing at least one of the microwave absorbing structures to microwave energy; and degrading the contaminants trapped in the filter.

Other structures, methods, features, and advantages of the present disclosure will be, or become, apparent to one with skill in the art upon examination of the following drawings and detailed description. It is intended that all such additional structures, methods, features, and advantages be included within this description, be within the scope of the present disclosure, and be protected by the accompanying claims.

### BRIEF DESCRIPTION OF THE DRAWINGS

Many aspects of the disclosed devices and methods can be better understood with reference to the following drawings. The components in the drawings are not necessarily to scale, emphasis instead being placed upon clearly illustrating the relevant principles. Moreover, in the drawings, like reference numerals designate corresponding parts throughout the several views.

FIG. 1 illustrates an exemplar embodiment of the present disclosure.

FIG. 2 is a graph that illustrates the temperature of the filters as a function of microwave application time at three different microwave power levels.

FIG. 3A illustrates a Log inactivation efficiency by microwave irradiation assisted filtration system. FIG. 3B illustrates the Log survival fraction on filter surface as a function of microwave application time at three different microwave power levels with a SiC disk.

FIG. 4A illustrates the Log inactivation efficiency by microwave irradiation assisted filtration system. FIG. 4B illustrates the Log survival fraction on a filter surface as a function of microwave application time at 375 W under three relative humidity levels with a quartz frit.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of environmental engineering, biology, microbiology, chemistry, materials science, mechanical engineering, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

It must be noted that, as used in the specification and the appended claims, the singular forms “a,” “an,” and “the” include plural referents unless the context clearly dictates otherwise. Thus, for example, reference to “a compound” includes a plurality of compounds. In this specification and in the claims that follow, reference will be made to a number of terms that shall be defined to have the following meanings unless a contrary intention is apparent.

### Definitions

The term “environment” as used herein refers to those in the gas phase. In an embodiment, the environment is a HVAC system or a stand-alone filter system.

The term “degrade”, “degrading”, or “degradation” refers to, but is not limited to, the degradation of the contaminant so that it is not harmful, the conversion of the contaminant into another compound that is either less toxic or nontoxic, and/or the destruction of the contaminant into a carbonized material, by embodiments of the present disclosure.

In an embodiment, the contaminant can include microorganisms such as bacteria, fungi, protozoans, algae, spores of any of these, endospores of any of these, and the like.

The terms “bacteria” or “bacterium” include, but are not limited to, Gram positive and Gram negative bacteria and endospores of these.

The term “protozoan” as used herein includes the following as well as cysts of the following: flagellates (e.g., Giardia lamblia), amoeboids (e.g., Entamoeba histolitica), sporozoans (e.g., Plasmodium knowlesi), and ciliates (e.g., B. coli).

The term “algae” as used herein includes the following as well as spores of any of the following: microalgae and filamentous algae.

The term “fungi” as used herein includes the following as well as spores of any of the following: molds, mildews and rusts.

The terms “contaminant” or “contaminants” can include volatile organic compounds (VOCs), chemical warfare agents, and also include the following: aldehydes, aliphatic nitrogen compounds, sulfur compounds, aliphatic oxygenated compounds, halogenated compounds, organophosphate compounds, phosphonothionate compounds, phosphorothionate compounds, arsenic compounds, chloroethyl compounds, phosgene, cyanic compounds, or combinations thereof. In one embodiment, the contaminant is acetaldehyde, methyl mercaptan, ammonia, hydrogen sulfide, diethyl sulfide, diethyl disulfide, dimethyl sulfide, dimethyl disulfide, trimethylamine, styrene, propionic acid, n-butyric acid, n-valeric acid, iso-valeric acid, pyridine, formaldehyde, 2-chloroethyl ethyl sulfide, carbon monoxide, or combinations thereof.

The phrase “fluoropolymer fiber” includes a fluoropolymer, where the fluoropolymer includes at least one fluorine-containing monomer and can be a homopolymer, copolymer, and terpolymer. Embodiments of the fluoropolymer can include polymers such as, but not limited to, polytetrafluoroethylene (PTFE), fluorinated ethylene-propylene (FEP), perfluoroalkoxy polymer resin (PFA), polychlorotrifluoroethylene (PCTFE), polytrifluoroethylene, polyvinylidene fluoride (PVDF), polyvinyl fluoride (PVF), tetrafluoroethylene-ethylene copolymer resin (ETFE), fluoroethylene propylene ether resin (EPE), copolymers of each, terpolymers of each, and the like.

As used herein, the term “PTFE” includes polytetrafluoroethylene as well as its derivatives, composites and copolymers thereof, wherein the bulk of the copolymer material can be polytetrafluoroethylene, including copolymers of tetrafluoroethylene and hexafluoro(propyl vinyl ether), copolymers of tetrafluoroethylene and perfluoro-2,2-dimethyl-1,3-dioxole, and copolymers of tetrafluoroethylene and vinyl fluoride, poly(vinyl fluoride), poly(vinylidene fluoride), polychlorotrifluoroethylene, vinyl fluoride/vinylidene fluoride copolymer, vinylidene fluoride/hexafluoropropylene copolymer, perfluoroalkoxy polymer resin (PFA), and/or fluorinated ethylene-propylene (FEP). Where the term “PTFE” is used herein to describe polytetrafluoroethylene that is copolymerized with one of the above-named polymers, it is contemplated that the actual polytetrafluoroethylene content in the copolymer can be about 80% by weight, or higher, although lower amounts are also contemplated depending on the desired properties of the resulting PTFE-based compound.

### Discussion

In accordance with the purpose(s) of the present disclosure, as embodied and broadly described herein, embodiments of the present disclosure, in one aspect, relate to microwave filter air purification systems, methods of using the microwave filter air purification systems, microwave absorbing filter packs, methods of degrading a contaminant, and the like. Embodiments of the present disclosure are able to degrade a contaminant on a filter surface by heating the filter indirectly using microwave energy. In an embodiment, the filter can increase in temperature from about room temperature (25° C.) to 50 or 100° C. or greater in a matter of seconds (e.g., about 90 seconds or less in some instances) by exposing (e.g., irradiating) the filter or microwave absorbing filter pact to a certain microwave energy (e.g., about 500 W or more). The contaminant can be a biological contaminant (e.g., a spore) and/or a chemical contaminant (e.g., volatile organic compound). Embodiments of the present disclosure can quickly degrade contaminants on a filter in a short period of time (e.g., seconds to minutes for intermittent time periods or continuous exposure). Embodiments of the present disclosure can be used in HVAC systems, portable filter systems, and other air circulation or air control systems. Additional details are provided below and in the Example section.

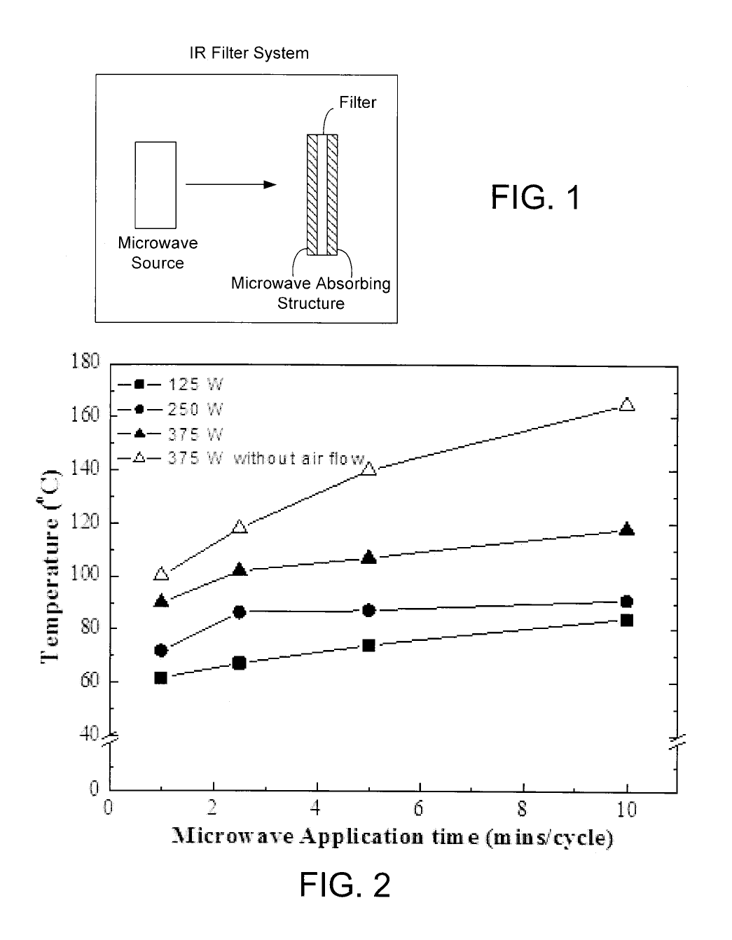

In an embodiment, the microwave filter air purification system includes a microwave source and a microwave absorbing filter pack (e.g., See FIG. 1). In an embodiment, the microwave source produces microwave energy that can be directed to the microwave filter pack through the use of a waveguide. In other embodiments, one or more microwave sources can be positioned on one or both sides of the microwave absorbing filter pack and/or at one or more angles relative to the microwave absorbing filter pack. In any of the embodiments described herein, the microwave source can be turned on for short periods of time (e.g., seconds or minutes) or can be on for longer periods of time (e.g., hours or days) for continuous operation. In an embodiment, the microwave source can be a magnetron. In an embodiment the microwave source can be regularly (e.g., every few seconds) turned on and off so that the microwave absorbing filter pack maintains a temperature (or range) for a period of time. The time that the microwave source is on, the number of microwave sources, the relative position of the microwave source(s) to the microwave absorbing filter pack, and/or the relative position of the microwave source(s) in the microwave filter air purification system, depends, at least in part, upon the intended use of the microwave filter air purification system, the exposure to contaminants, the type of contaminants, and the like.

In an embodiment, the microwave absorbing filter pack can include a microwave absorbing filter that is made of a microwave absorbing material such as silicon carbide, titanium dioxide, aluminum, vanadium pentoxide, or a combination thereof. In an embodiment, the air flow is about 1 cm/s or less. The microwave absorbing filter can include a fibrous filter, a porous membrane filter, a granular bed filter, or a combination thereof, as described below. The heating, exposure, and use parameters described below for the microwave absorbing filter pack are generally applicable to the microwave absorbing filter.

For general ventilation systems with a higher flow velocity, the microwave absorbing filter pack includes a pair of microwave absorbing structures and a filter disposed between the pair of microwave absorbing structures. In an embodiment, the filter is positioned between the pair of microwave absorbing structures so that each side of the filter is in contact (or in proximity for the filter or the material disposed on the filter to be heated by the microwave absorbing structures) with the corresponding microwave absorbing structure. In an embodiment, each of the microwave absorbing structures can be disposed (e.g., adjacent or in contact with) in a plane parallel to the filter (e.g., each on opposite sides of the filter) so that heat from the microwave absorbing structures causes the filter or the materials disposed on the filter to increase in temperature. In an embodiment, each of the microwave absorbing structures is disposed in a plane parallel to the filter and is in direct physical contact with the filter, each along one side of the filter. The microwave energy absorbed by the microwave absorbing structures is converted into thermal energy (heat) that is then absorbed by the contaminant(s) disposed on the filter. The temperature and/or time frame can be adjusted accordingly to decontaminate one or more types of materials on the filter. The microwave absorbing filter pack allows an air flow to pass through it in a way similar to the air flow used in a standard HVAC filter system.

In an embodiment, the microwave absorbing filter pack is adapted to absorb microwave energy and/or can heat the material disposed on the surface of the filter. The microwave absorbing structure converts the microwave energy into thermal energy so that the microwave absorbing filter pack increases in temperature. The temperature increases as the source power increases. In an embodiment, the temperature can increase 100° C. or more in a matter of seconds (e.g., about 90 seconds at about 500 W) or minutes. The temperature can be held for a period of time from seconds to minutes to hours. The speed of the temperature increase will depend, at least in part, upon the intended use of the microwave filter air purification system pack, the materials of the filter, the exposure to contaminants, the type of contaminants, the microwave source, the power of the microwave source (e.g., about 100 to 1000 W) and the like. Although the microwave absorbing filter pack can be heated to very high temperatures in a short period of time (e.g., 90 seconds), it is contemplated that longer time periods may be desired so embodiments of the present disclosure are not intended to be limited to a few seconds or minutes, but could extend to longer periods of time.

The temperature can vary depending on the contaminant to be decontaminated or inactivated. For example E. coli can be killed at about 50° C., MS2 bacteriophage can be inactivated completely at about 75° C., and B. subtilus spores can be killed at about 135° C. Chemical contaminants can be degraded at higher temperatures. Thus, the temperature used in a particular setting can vary from 50° C. to several hundred degrees C. It should also be noted that the time of the exposure can alter the temperature necessary to decontaminate, inactivate, or degrade the contaminant in question. Thus, the temperature and exposure time can be adjusted as needed for specific uses.

In an embodiment, the microwave absorbing structure can include ceramic materials that function as a thermal storage. The microwave energy absorbed by the microwave absorbing structure raises the temperature of the ceramic to the desired level. After the microwave source is turned off, due to the low thermal conductivity, the thermal storage ceramic materials release heat to the air slowly so that the temperature can still be maintained at an appropriate level for decontamination for an extended period of time.

As noted above, the microwave absorbing structure can absorb microwave energy, and convert the microwave energy to heat that is then absorbed by the filter or ceramic material, or is used to heat the material disposed on the filter. The pair of microwave absorbing structures can be constructed of the same or different materials and/or of the same or different design. The microwave absorbing structure can be made of a material such as activated carbon, silicon carbide, titanium oxide, vanadium pentoxide, aluminum, and a combination thereof. The microwave absorbing structure can be about 1 mm to 10 cm thick, and the length and width can be on the order of cm to meters depending on the particular application. The microwave absorbing structure is not intended to be a filter and the microwave absorbing structure does not significantly impede the air flow. If contaminants are disposed on the microwave absorbing structure, the contaminants are heated and may be destroyed faster than if they were disposed on the filter. The microwave absorbing structure is designed (e.g., spaces among the fibers for air to pass through) so that air can flow through it at the same rate, similar rate as the air flow passes through the filter, or at an acceptable rate for the desired application. The type (e.g., material, size, and the like) of microwave absorbing structure can depend, at least in part, upon the intended use of the microwave filter air purification system, the exposure to contaminants, the type of contaminants, and the like.

As noted above, the filter is positioned between the pair of microwave absorbing structures and absorbs heat from the microwave absorbing structures. The filter can filter out materials (e.g., contaminants) present in the air flow. In an embodiment, the filter can operate in a HEPA, a hyperHEPA, ULPA, commercial HVAC, and the like, system. The filter can be made of a material such as glass fiber, fluoropolymer fiber (e.g., Teflon®) or granules, polymer, carbon, ceramic, and a combination thereof. The filter can be a fibrous filter, a porous membrane filter, a granular bed filter, or a combination thereof A fibrous filter includes fibers having a diameter on the order of about 10 nm to 10 μm. In an embodiment, the diameter of the fibers is about 20 to 80 nm. A porous membrane filter is a membrane with pores of about 100 nm to 10 μm. A granular bed filter includes granules with pores on each granule and between granules from about 10 nm to 100 μm. The filter can be about 1 μm to 10 cm thick, and the length and width can be on the order of cm to meters depending on the particular application. The type (e.g., material, size, and the like) of filter can depend, at least in part, upon the intended use of the microwave filter air purification system, the exposure to contaminants, the type of contaminants, and the like.

In an embodiment, a method includes trapping contaminants in the microwave absorbing filter pack. Periodically, the microwave absorbing filter pack can be exposed to microwave energy from one or more microwave sources. The configuration of the microwave sources can be any one of those described herein or within the scope of this disclosure. The microwave absorbing filter pack (e.g., microwave absorbing structures) absorbs microwave energy causing the microwave absorbing filter pack to increase in temperature from about room temperature to about 500° C. or greater. In an embodiment the increase in temperature of the microwave absorbing filter pack can occur within a few minutes (e.g., about 10 minutes, but the time is dependent, at least in part, upon the desired temperature). After a sufficient period of time, the contaminant trapped in the microwave absorbing filter pack is degraded. The degree of degradation can depend upon the time that the microwave source is on, the microwave power level, the temperature of the microwave absorbing filter pack, the time that the filter is held at a high temperature, the type of contaminant, and the like. The use and design can be used to determine the configuration of the microwave absorbing filter pack (e.g., the type of microwave absorbing structure, the microwave source, the temperature, the time that the temperature is sustained, and the like).

Embodiments of the present disclosure are capable of degrading a single contaminant or multiple contaminants in an environment. In an embodiment, the contaminant can include a biological contaminant and/or a chemical contaminant. In embodiments where it is desired to degrade a chemical contaminant, the temperature of the microwave filter air purification system may need to be raised higher and/or for a longer time frame than if only a biological contaminant is to be degraded. As described herein, embodiments of the present disclosure are capable of reaching temperatures that can degrade chemical contaminants and can hold those temperatures for a time period so that the chemical contaminant is degraded efficiently and effectively.

### EXAMPLES

Now having described the embodiments of the present disclosure, in general, the examples describe some additional embodiments of the present disclosure. While embodiments of the present disclosure are described in connection with the examples and the corresponding text and figures, there is no intent to limit embodiments of the present disclosure to these descriptions. On the contrary, the intent is to cover all alternatives, modifications, and equivalents included within the spirit and scope of embodiments of the present disclosure.

### Example 1

Experiments were conducted using a SiC-PAN(Polyacrylonitrile)-SiC filter pack for E. coli (bacterium), B. subtilus (bacterium) endospores, and MS2 (bacteriophage). Measurements were made for disinfection of E. coli and B. subtilus collected on the filter. Under 125, 250 and 500 W of microwave irradiation for 30 minutes and air flow velocity of 5.3 cm/s, the log-disinfection efficiency for E. coli was 1.6, 2.9 and 3.8, respectively. Herein, 1-log is 90%, 2-logs is 99%, 3-logs is 99.9%, 4-logs is 99.99%, and 5-logs is 99.999%. Spores are more resistant and require a higher power for effective inactivation. Under 250, 500 and 750 W of microwave irradiation for 30 minutes and air flow velocity of 6.6 cm/s, the log-disinfection efficiency for B. subtilus endospores was 0.6, 2.0 and 2.8. Experiments were also carried out for reduced irradiation time per 10-minutes cycles at the end of cycle for three cycles at 750 W. The log-disinfection efficiency for 5 minutes per 10 minutes and 1.25 minutes per 10 minutes was 1.7 and 0.7, respectively, compared to 2.8 for 10 minutes per 10 minutes. By lowering the flow velocity to reduce heat dissipation, the effectiveness can be further increased. For example, the log-disinfection efficiency increased to 1.2 from 0.7 when the flow velocity decreased to 3.3 cm/s from 6.6 cm/s for 1.25 minutes per 10 minutes at 750 W.

For MS2, measurements were made for disinfection of viruses that pass through the filter pack. Under 125, 250, 375 and 500 W of microwave irradiation for 30 minutes and air flow velocity of 5.3 cm/s, the log-disinfection efficiency was 0.5, 0.7, 2, and 2.5, respectively. Experiments were also carried out for reduced irradiation time per 10-minutes cycles at the end of cycle for three cycles. The log-disinfection efficiency for 5 minutes per 10 minutes, 3.3 minutes per 10 minutes, 2 minutes per 10 minutes and 1.25 minutes per 10 minutes was 1.9, 1.7, 1.4 and 1.4, respectively, compared to 2.5 for 10 minutes per 10 minutes.

Destruction of chemical agents was also accomplished by using a SiC-glassfiber-SiC filter pack. Dimethyl methylphosphonate (DMMP) was tested under 2.55 KW for 30 minutes. The destruction efficiency was 91% at 5 cm/s flow velocity, and it increased to 95% when the flow was lowered to 4 cm/s. Tests were also done for SiC—TiO₂ nanofiber mat-SiC filter pack. The destruction efficiency for DMMP was 99.8% under 300 W for 20 minutes at 5.4 cm/s flow velocity.

### Example 2

Additional testing was conducted using commercial ventilation filters made of polypropylene or glassfiber. The filter was supported on a SiC disc downstream of the filter. The SiC also served as the microwave absorber to allow an enhanced temperature increase rate. Flow velocity was 5.3 cm/s, and MS2 bacteriophage was used as the testing agent. Microwave power was turned on for 1, 2.5, 5 and 10 minutes per 10 minutes cycle. Microwave power levels of 125, 250 and 375 W were used.

FIG. 2 shows the temperature increase as a function of microwave run time per 10 minutes cycle. With a flow velocity of 5.3 cm/s, the temperature quickly reached the steady-state value within 2.5 minutes of microwave application. Without air flow, the temperature continued to increase and it was higher than those with air flow.

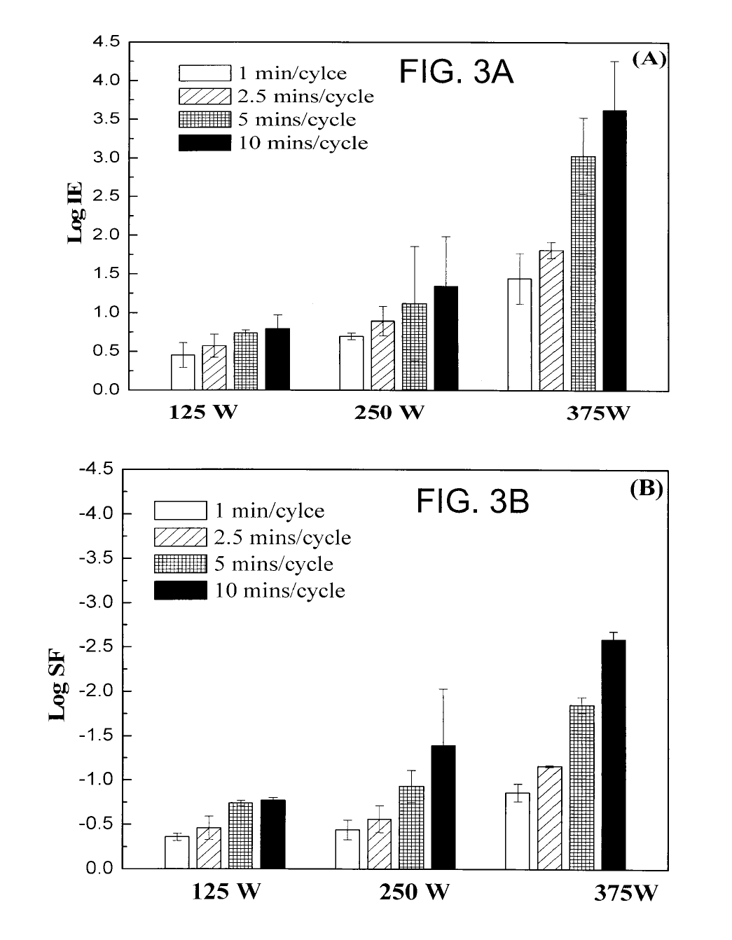

FIG. 3 shows the inactivation efficiency and survival fraction of the polypropylene filter as a function of microwave power and application time. Herein, inactivation efficiency is the fraction of viable MS2 aerosol downstream the filter compared to the upstream concentration. Inactivation efficiency is contributed by both mechanical filtration as well as microwave inactivation when the MS2 passes through the filter. The higher the value obtained, the better the process. Survival fraction is the fraction of viable MS2 on the filter after microwave irradiation compared to the total count of MS2 collected on the filter. Survival fraction is determined by microwave inactivation and not dependent of mechanical filtration. The lower the value obtained; the better the performance. As shown in FIG. 3A, the inactivation efficiency increased as microwave power level and application time increased. Meanwhile, the survival fraction decreased as microwave power level and application time increased (note the negative value in log scale). Both agree with the expected trend and demonstrate the ease of controlling the treatment process. Filters were inspected after testing, and no damage was observed in these testing conditions. They were also tested for pressure drop, and the results showed no difference, indicating no impact of the microwave process on filtration performance under these conditions.

Polypropylene filter melts above 120° C. Hence, tests with polypropylene filter were conducted with microwave power up to 375 W only. Glassfiber filter can survive up to 425° C. Hence, tests were conducted for higher microwave power levels using glassfiber filter. Table 1 shows the results. A shown, the inactivation efficiency greatly increased and survival fraction significantly decreased as microwave power level and application time increased, compared to the test results with polypropylene filter at lower microwave power. With filter material that can sustain high temperature, the results demonstrate the great capability of the technology.

TABLE 1
Log inactivation and survival fraction of glassfiber filter at 375 W,
500 W, and 750 W

| Power level | Application time | | Log IE | Log SF |
|---|---|---|---|---|
| 375 W | 1 | min/cycle | 1.50 | −0.74 |
| | 2.5 | mins/cycle | 1.78 | −1.19 |
| | 5 | mins/cycle | 2.40 | −1.79 |
| | 10 | mins/cycle | 3.59 | −2.35 |
| 500 W | 1 | min/cycle | 1.31 | −1.12 |
| | 2.5 | mins/cycle | 2.67 | −2.54 |
| | 5 | mins/cycle | 4.09 | −3.09 |
| | 10 | mins/cycle | 4.48 | −3.47 |
| 750 W | 1 | min/cycle | 1.65 | −1.24 |
| | 2.5 | mins/cycle | 2.97 | −2.59 |
| | 5 | mins/cycle | 4.62 | −3.48 |
| | 10 | mins/cycle | 5.36 | −4.23 |

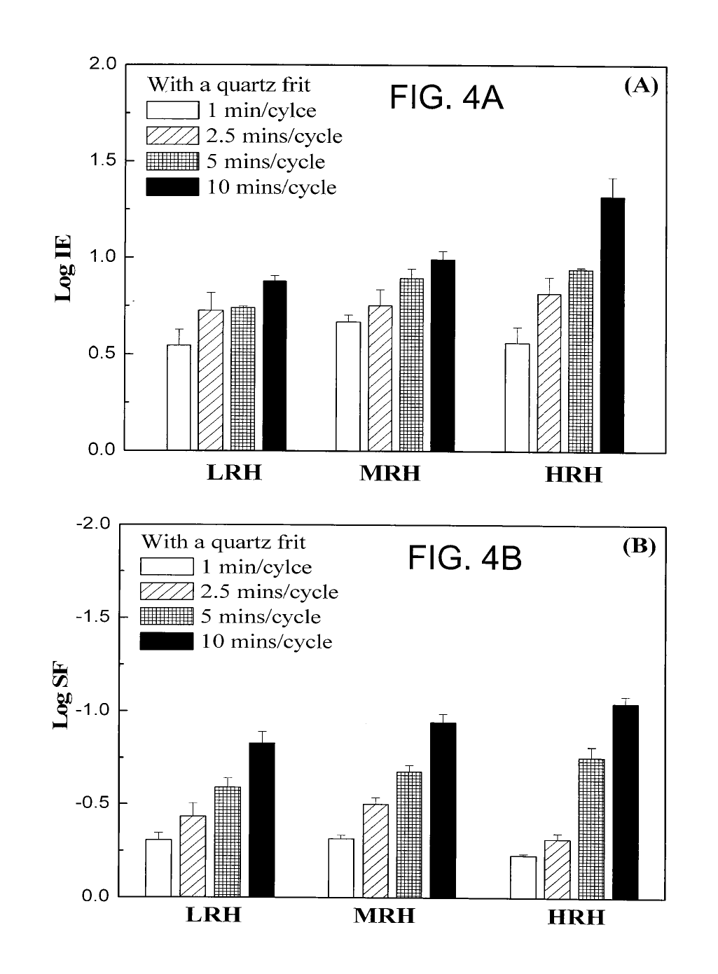

Another important factor of the technology is humidity. In this test, the SiC disc was not used. Instead, the filter was supported on a quartz frit only, which is not an effective microwave absorber. FIG. 4 shows the test results for polypropylene filter at different relative humidity levels. As shown, the inactivation efficiency increased and the survival fraction decreased as relative humidity increased. The results demonstrate that relative humidity can be used to easily enhance the performance of the technology, e.g. introducing water vapor or high humidity air.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

We claim:

1. A microwave filter air purification system, comprising:
a microwave source; and
a microwave absorbing filter, wherein the microwave absorbing filter is positioned for an air flow to pass through the microwave absorbing filter, wherein the microwave source is positioned relative to the microwave absorbing filter so that the microwave radiation from the microwave source is absorbed by the microwave absorbing filter.

2. The microwave filter air purification system of claim 1, wherein the microwave absorbing filter is made of a material selected from the group consisting of: silicon carbide, carbon, titanium dioxide, vanadium pentoxide, aluminum, and a combination thereof.

3. The microwave filter air purification system of claim 1, wherein each microwave absorbing filter is selected from the group consisting of: a fibrous filter, a porous membrane filter or a granular bed filter, and a combination thereof.

4. A microwave filter air purification system, comprising:
a microwave source; and
a microwave absorbing filter pack including a pair of microwave absorbing structures and a filter disposed between the pair of microwave absorbing structures, wherein the microwave absorbing filter pack is positioned for an air flow to pass through the microwave absorbing filter pack, wherein the microwave source is positioned relative to the microwave absorbing filter pack so that the microwave radiation from the microwave source is absorbed by the microwave absorbing filter pack.

5. The microwave filter air purification system of claim 4, wherein the microwave absorbing structures are made of a material selected from the group consisting of: silicon carbide, carbon, titanium dioxide, vanadium pentoxide, aluminum, and a combination thereof.

6. The microwave filter air purification system of claim 4, wherein the filter is made of a material selected from the group consisting of: a glass fiber, a fluoropolymer fiber, a polymer, and a ceramic.

7. A method of degrading contaminants, comprising of:
providing a microwave filter air purification system of claim 1,
trapping contaminants in the filter;
exposing the microwave absorbing structures to microwave energy; and
degrading the contaminants trapped in the filter.

8. The method of claim 7, wherein each microwave absorbing filter is selected from the group consisting of: a fibrous filter, a porous membrane filter or a granular bed filter, and a combination thereof.

9. The method of claim 7, wherein the power level of the microwave energy generates energy to increase the temperature to about 50° C. or more.

10. The method of claim 7, wherein the temperature increases to about 50° C. or more and the microwave absorbing structures are exposed to microwave energy for about 10 minutes or more.

11. The method of claim 7, where the filter pack functions as a thermal storage that extends the duration of high temperature for degradation after microwave power is turned off.

12. A microwave absorbing filter pack, comprising:
a pair of microwave absorbing structures and a filter disposed between the pair of microwave absorbing structures, wherein the pair of microwave absorbing structures and the filter are positioned for an air flow to pass through the pair of microwave absorbing structures and the filter, wherein the microwave source is positioned relative to the microwave absorbing filter pack so that the microwave radiation from the microwave source is absorbed by the microwave absorbing filter pack.

13. The filter pack of claim 12, wherein the microwave absorbing structures are made of a material selected from the group consisting of: silicon carbide, carbon, titanium dioxide, vanadium pentoxide, aluminum, and a combination thereof.

14. The filter pack of claim 12, wherein each of the microwave absorbing structures includes a plurality of fibers, wherein each fiber is about 10 nm to 10 μm.

15. The filter pack of claim 12, wherein each of the microwave absorbing structures includes a porous membrane, wherein each pore is about 100 nm to 10 μm.

16. The filter pack of claim 12, wherein each of the microwave absorbing structures includes a plurality of granules, wherein the pore on each granule or between granules is about 10 nm to 100 μm.

17. The filter pack of claim 12, wherein the filter is made of a material chosen from a glass fiber, a fluoropolymer fiber, a polymer and a ceramic.

18. A method of degrading contaminants, comprising:
providing a filter pack of claim 12,
trapping contaminants in the filter;
exposing at least one of the microwave absorbing structures to microwave energy; and
degrading the contaminants trapped in the filter.

19. The method of claim 18, wherein the power level of the microwave energy generates heat to increase the temperature to about 50° C. or more.

20. The method of claim 18, wherein the temperature increases to about 50° C. or more and the microwave absorbing structures are exposed to microwave energy for about 10 minutes or more.

21. The method of claim 18, where the filter pack functions as a thermal storage that extends the duration of high temperature for degradation after microwave power is turned off.
